(19) United States
(12) Patent Application Publication
(10) Pub. No.: US 2025/0122901 A1
(43) Pub. Date: Apr. 17, 2025

(54) DEVICE FOR COMPENSATING FOR TOLERANCES

(71) Applicant: WITTE Automotive GmbH, Velbert (DE)

(72) Inventors: Harry PURWIN, Ratingen (DE); Volkan KANDEMIR, Essen (DE)

(21) Appl. No.: 18/916,833

(22) Filed: Oct. 16, 2024

(30) Foreign Application Priority Data
Oct. 16, 2023 (DE) 10 2023 210 118.1
Dec. 29, 2023 (DE) 10 2023 213 351.2

(51) Int. Cl. F16B 37/12; F16B 5/02; F16B 43/00

(52) U.S. Cl. CPC F16B 37/12; F16B 5/025; F16B 43/00

(57) ABSTRACT

A device for compensating for tolerances between a first component and a second component that is to be connected, in particular screwed, to this first component by means of a connecting bolt, in particular a connecting screw or a threaded bolt. The device may have a base element, a compensation element in tolerance-compensating engagement with the base element and a positioning element for positioning the connecting bolt in the compensation element. The positioning element is mounted with a clearance in at least one degree of freedom or without clearance in a through-opening in the compensation element.

### FIELD

The invention relates to a device for compensating for tolerances between a first component and a second component to be screwed to the first component by means of a connecting screw.

### BACKGROUND

In a known tolerance compensation device of this type, the base element and the compensation element are formed by in particular metallic threaded sleeves which engage in a left-hand thread. A spring element is arranged in the compensation element, which produces a frictional connection between the connecting screw which is passed through the tolerance compensation device and has a right-hand thread and the compensation element, so that when the connecting screw is tightened a torque is exerted on the compensation element which prevents the compensation element from being unscrewed from the base element against the direction of insertion of the connecting screw.

The purpose of the present invention is to provide a device for compensating for tolerances that can be easily installed.

According to the invention, the object is achieved by a device having the features of claim 1.

### SUMMARY

The device according to the invention for compensating for tolerances between a first component and a second component to be connected, in particular screwed, to this first component by means of a connecting bolt, in particular a connecting screw or a threaded bolt, comprises at least one base element, a compensation element in tolerance-compensating engagement with the base element and a positioning element for positioning the connecting bolt in the compensation element, wherein the positioning element is mounted with a clearance in at least one degree of freedom in an, in particular axial, through-opening in the compensation element. In addition, the connecting bolt, in particular the connecting screw or the threaded bolt, can be pre-positioned and detachably held in the positioning element, in particular in a delivery state of the device.

In particular, the connecting bolt can be designed as a connecting screw or a threaded bolt. The connecting bolt is also called a connecting screw.

The advantages achieved with the invention consist in particular of the fact that the positioning element for positioning the connecting screw in the compensation element allow for a simple and quick assembly, in particular so-called blind assembly, of the device. The positioning element also secures the connecting screw against tilting.

The positioning element is configured and arranged in the compensation element in such a way that the connecting screw is pre-assembled and held in an uppermost and central position in the delivery state of the device. In particular, the positioning element can be configured and held in the compensation element in such a way that the connecting screw is held so as to be axially and/or radially movable and detachable relative to the compensation element. In particular, the positioning element can be configured and held in the compensation element in such a way that the connecting screw is held detachably relative to the compensation element without tilting.

The positioning element can be designed as a sleeve, in particular a plastic sleeve, with an entry funnel for inserting a tool for a screw head of the connecting screw. The screw head can be held centered and detachable in the positioning element. During assembly, the connecting screw can move in the direction of the second component by applying an axial force to the screw head until it engages with it, and the two components and the positioning element are clamped and connected to one another.

In a delivery state of the device and prior to installation, the connecting screw can be held in the positioning element in a captive manner, in particular with a form-fit and/or force-fit, in particular with a frictional connection.

In a further exemplary embodiment, the positioning element can be configured in such a way that the connecting screw is held centered in the through-hole. In particular, the connecting screw can be held indirectly centered in the through-hole of the compensation element by means of the positioning element.

In addition, the positioning element can be configured and arranged in the compensation element in such a way that the connecting screw is held securely in a predetermined position prior to assembly. Preferably, the positioning element can be configured and arranged in the compensation element in such a way that the connecting screw is held securely in a predetermined axial position prior to assembly. In particular, the connecting screw can be held securely in a predetermined uppermost axial position. For example, the connecting screw is held securely in the predetermined uppermost axial position by means of the positioning element in such a way that the connecting screw and the compensation element are flush with one another in an upper plane or the connecting screw lies within the through-opening. In other words, the connecting screw does not protrude from the through-opening.

In addition, the positioning element can be configured in such a way that the connecting screw is held securely in the positioning element against tilting. This allows a blind assembly of the two components by means of the tilt-free connecting screw simply and securely.

For example, the positioning element can comprise a number of elastic elements, for example tensioning elements, radial compensation spring elements, propeller arms or the like, which are configured to radially compensate for tolerances between the connecting screw and the compensation element.

In particular, the positioning element can comprise a base body from which the elastic elements protrude radially outwards at an acute angle. The base body of the positioning element has, for example, an inner receiving channel for the connecting screw. In particular, the receiving channel comprises an internal dimension that is smaller than an external dimension of the connecting screw, so that it is held in the receiving channel in the inserted state.

In addition, the base body can comprise a plurality of flexible wall sections distributed in the circumferential direction, which form an inner wall of the inner receiving channel. The flexible wall sections can form a driver section. The driver section is configured in particular to create a frictional connection between the connecting bolt and the compensation element when connecting the two components, so that when the connecting bolt is tightened, for example turned, a torque is exerted on the, in particular axial, compensation element, which causes the compensation element to unscrew axially from the first component against the direction of insertion of the connecting bolt and thus compensates for axial tolerances.

### DESCRIPTION OF THE FIGURES

Exemplary embodiments of the invention are explained in greater detail with reference to the drawings. In the figures:

FIG. 1 is a schematic sectional view of a device for compensating for tolerances with a positioning element for a connecting screw,

FIG. 2 is a schematic sectional view of the device shown in FIG. 1 prior to assembly and during alignment with one of the components,

FIG. 3 is a schematic sectional view of the device in FIG. 1 in the assembled state,

FIG. 4 is a schematic sectional view of an alternative device,

FIG. 5 is a schematic, partially sectioned perspective view of a further alternative device,

FIG. 6 is a schematic sectional view of a further alternative device with centrally arranged positioning element,

FIG. 7 is a schematic sectional view of a further alternative device with radially deflected positioning element, and

FIG. 8 is a schematic sectional view of a further alternative device with tilted positioning element.

### DETAILED DESCRIPTION

Parts corresponding to one another are provided with the same reference signs in all the drawings.

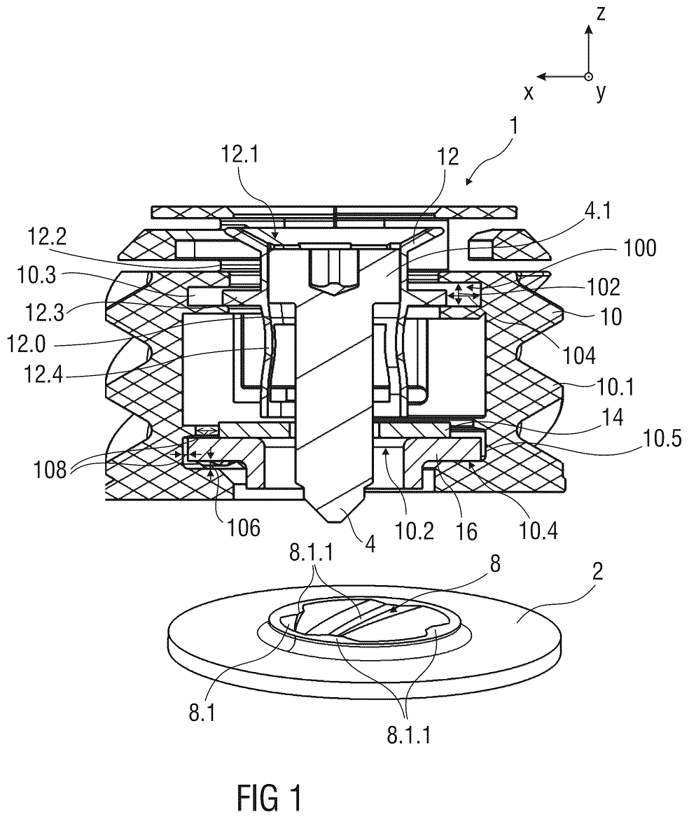

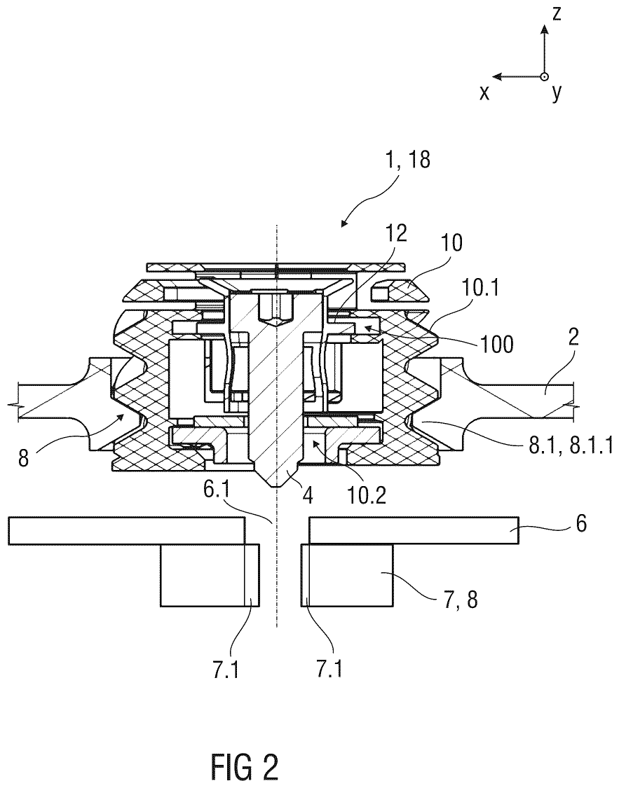

FIG. 1 is a schematic sectional view of a device 1 for compensating for tolerances between a first component 2 and a second component 6 (shown in FIG. 2) that is to be connected, in particular screwed, to this first component 2 by means of a connecting bolt 4, in particular a connecting screw or a threaded bolt (hereinafter referred to as connecting screw 4).

The first component 2, for example, can be a bearing bracket for an external door handle of a motor vehicle, while the second component 6 can be formed, for example, by a support structure of the motor vehicle.

The device 1 comprises at least one base element 8 and a compensation element 10 in threaded engagement with the first component 2 via the base element 8.

The base element 8, for example, is designed as a hollow cylindrical element, which can be firmly connected to the first component 2, for example clipped, pressed, glued or welded into it. The base element 8 can be a plastic part produced by means of an injection molding process. Alternatively, the base element 8 can also be formed in one piece with the first component 2. In this case as well, the base element 8 can be formed from plastic as part of the first component 2, for example by means of an injection molding process.

The base element 8 comprises an internal thread 8.1, which, however, is not continuous, but is formed by a plurality of thread sections 8.1.1, four in the present exemplary embodiment, arranged evenly distributed in the circumferential direction. All thread sections 8.1.1 comprise the same pitch, which is chosen to be so large that the thread of the base element 8 forms a steep thread.

The tolerance compensation device 1 further comprises the compensation element 10, which can be screwed into the first component 2 and, like the base element 8, can be formed from a plastic material, for example by means of an injection molding process. The compensation element 10 is designed as a hollow cylindrical element. The compensation element 10 comprises an external thread 10.1, for example. The compensation element 10 comprises an axial through-opening 10.2 for the connecting screw 4. The axial through-opening 10.2 is designed to be larger than the outer diameter of the connecting screw 4.

The device 1 also comprises a positioning element 12 for positioning the connecting screw 4 in the compensation element 10, in particular in the axial through-opening 10.2.

The compensation element 10 is designed in such a way that the positioning element 12 is mounted with a clearance 100, in particular an axial clearance 102 and a radial clearance 104, in at least one degree of freedom, for example in the x-direction, in the z-direction and/or in the y-direction, in the axial through-opening 10.2 in the compensation element 10. In addition, the connecting screw 4 can be pre-positioned in the positioning element 12, in particular in a delivery state of the device 1, and held in a detachable, in particular captive, manner.

By means of the positioning element 12, the connecting screw 4 can be mounted in the compensation element 10 quickly and easily, in particular blindly.

The positioning element 12 is configured and arranged in the compensation element 10 in such a way that the connecting screw 4 is held pre-assembled at an uppermost and central position in the delivery state of the device 1. In addition, the positioning element 12 can be configured and held in the compensation element 10 in such a way that the connecting screw 4 is held so that it can move axially and/or radially relative to the compensation element 10 in a detachable manner. In particular, the positioning element 12 can be configured and held in the compensation element 10 in such a way that the connecting screw 4 is held detachably without tilting relative to the compensation element 10.

The positioning element 12 can be designed as a sleeve 12.0, in particular a plastic sleeve, with an entry funnel 12.1 for the, in particular easier, introduction of a tool for a screw head 4.1 of the connecting screw 4.

The screw head 4.1 can be centered and detachably held in the positioning element 12.

During assembly, by applying an axial force to the screw head 4.1, the connecting screw 4 can move in the direction of the second component 6 (shown in FIG. 2) until it engages with it and clamps and connects the two components 2, 6 and the positioning element 12.

In a delivery state of the device 1 and prior to installation, the connecting screw 4 can be held in the positioning element 12 in a captive manner, in particular with a form-fit and/or force-fit, in particular with a frictional connection. For example, the positioning element 12 comprises a coupling section 12.2, which is configured to hold the screw head 4.1 with a form-fit and/or force-fit, in particular in a friction-fitting and detachable manner. For this purpose, the coupling section 12.2 is made of a flexible or elastic or compliant material, for example, and comprises a diameter that is equal to or slightly smaller than the outer diameter of the screw head 4.1. Due to the flexible, elastic or compliant material of the coupling section 12.2, the screw head 4.1 can be held detachably with a frictional connection. This ensures that, prior to the connection of the components 2 and 6, the connection screw 4 is held securely within the sleeve-shaped positioning element 12 both against falling out of the positioning element 12 and against tilting.

The positioning element 12 can in turn be held in the compensation element 10 with the axial clearance 102 and the radial clearance 104 in a captive manner. For this purpose, the positioning element 12 and the compensation element 10 comprise corresponding elements.

For example, the compensation element 10 can comprise an inner groove 10.3, in particular a circumferential inner groove 10.3.

The positioning element 12 can, for example, comprise a shoulder section 12.3. The shoulder section 12.3 can be formed around the circumference fully or in certain regions. In particular, the shoulder section 12.3 can be designed in the shape of an annular disk.

The inner groove 10.3 is designed in such a way that the shoulder section 12.3 is held in the inner groove 10.3 with an axial clearance 102 and/or a radial clearance 104. In particular, the inner groove 10.3 comprises a diameter and a height that are greater than the outer diameter and the height of the shoulder section 12.3.

The positioning element 12 also comprises a driver section 12.4. The driver section 12.4 is configured to create a further frictional connection between the connecting screw 4 and the axial compensation element 10 when connecting the two components 2 and 6, so that when tightening, for example turning, the connecting screw 4, a torque is exerted on the axial compensation element 10, which causes the compensation element 10 to unscrew axially from the first component 2 against the direction of insertion of the connecting screw 4 and thus compensates for axial tolerances.

In addition, a washer 14 serving as an opening reducer can be provided, which is arranged between the screw head 4.1 of the connecting screw 4 and a base section 10.4 of the compensation element 10 in the clamped together state between the two components 2, 6. The base section 10.4 is designed as the contact surface of the compensation element 10.

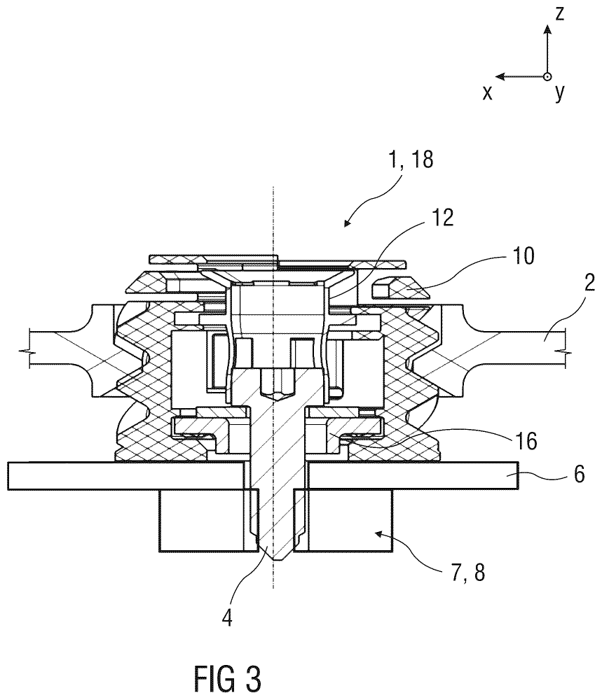

This washer 14 prevents the screw head 4.1 from entering the axial through-opening 10.2 of the compensation element 10. In this case, the bolt screw 4.1 of the connecting bolt 4 in the final assembly state (shown in FIG. 3) only indirectly, namely via the washer 14, abuts against the contact surface, the bottom section 10.4 of the compensation element 10.

In addition, the washer 14 can serve as an integrated compression limiter, which limits the flow of force in the plastic when the device 1 is made of plastic, and thereby limits or prevents undesired relaxation of the plastic. Alternatively, a separate compression limiter 16 can be provided, as shown, which is arranged in the base section 10.4 of the compensation element 10 in addition to the washer 14.

The washer 14 and/or the compression limiter 16 can or can also be arranged with a further radial clearance 108 and/or a further axial clearance 106 in the compensation element 10. For this purpose, the compensation element 10 can comprise a further inner groove 10.5.

The device 1 can be made of different materials or the same material. The base element 8 and/or the compensation element 10 and/or the positioning element 12 and optionally the washer 14 and/or the compression limiter 16 can be made of plastic, for example. The connecting screw 4 can be made of metal or plastic.

FIG. 2 is a schematic sectional view of the device 1 according to FIG. 1 prior to assembly and during alignment with the second component 6 with integrated nut element 7. The nut element 7 can be designed separately and comprise an inner nut thread 7.1. Alternatively, the inner nut thread 7.1 in a bore 6.1 of the second component 6 can be formed as an integrated internal thread or as thread pitches.

The device 1 is pre-assembled to form a pre-assembly unit 18. The pre-assembly unit 18 comprises the compensation element 10 and the positioning element 12 held therein with clearance 100 and the connecting screw 4 held in this positioning element 12 in a captive manner. The pre-assembly unit 18 is pre-assembled in the first component 2.

The first component 2 with the inserted, in particular screwed-in pre-assembly unit 18 is aligned over a bore 6.1 of the second component 6, so that the axial through-opening 10.2 and the bore 6.1 lie one above the other.

The connecting screw 4 is held in position by the positioning element 12 and guided axially and radially with the clearance 100.

FIG. 3 is a schematic sectional view of the device 1 according to FIG. 1 in the assembled state. The connecting screw 4 presses the device 1, in particular the pre-assembly unit 18, into position. The connecting screw 4 clamps the nut element 7 (=a further basic element 8 designed as a nut element) and the sleeve-shaped positioning element 12 and the compression limiter 16 together in the connected state.

The compensation element 10 and the base element 7 can be connected to one another via the thread connections with a form-fit.

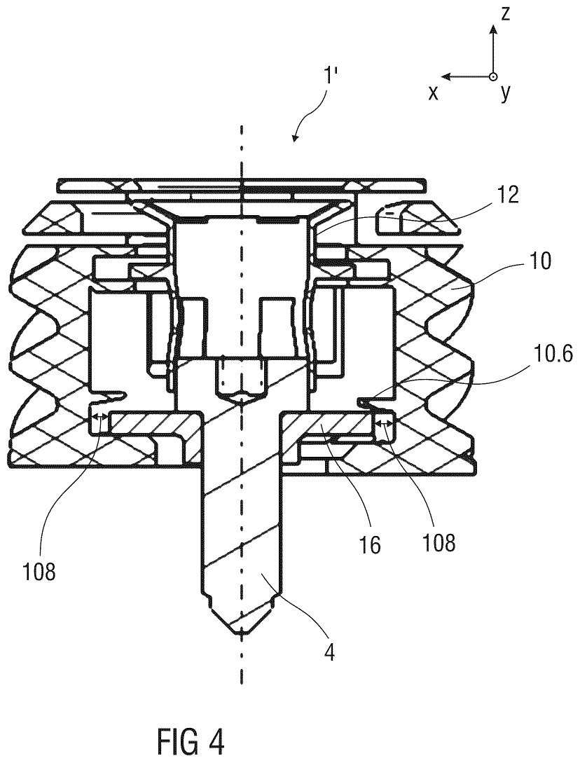

FIG. 4 is a schematic sectional view of an alternative device 1′.

The device 1′ differs from the device 1 in that the washer 14, in particular the washer 14 located inside the compensation element 10, is omitted and the compression limiter 16 with the further radial clearance 108 is arranged in the compensation element 10.

The compression limiter 16 can move radially, so a washer 14 (shown in FIG. 1) is no longer required. For axial limitation, the compensation element 10 comprises at least one radially inwardly extending limiting lip 10.6. The limiting lip 10.6 can be formed circumferentially or in sections. The limiting lip 10.6 can be made of a flexible material. The limiting lip 10.6 can also be designed as a rib, a connecting bar, a projection or the like.

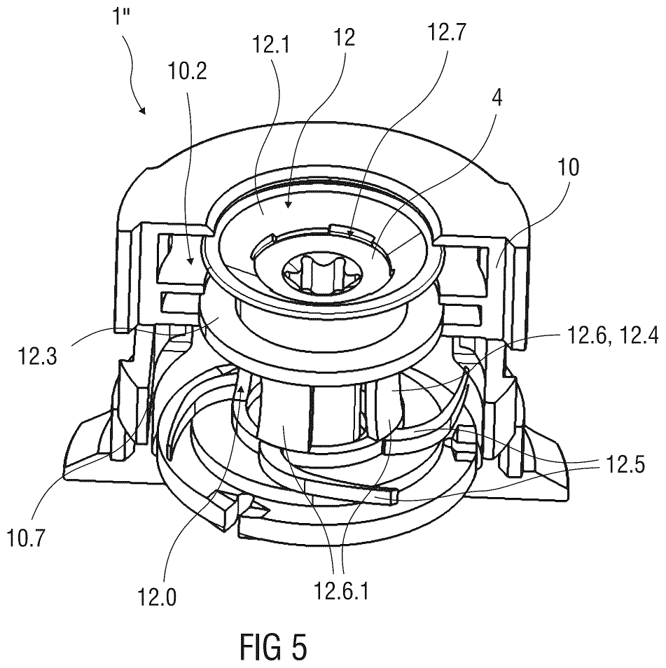

FIG. 5 is a schematic, partially sectioned perspective view of a further alternative device 1″.

The further alternative device 1″ differs from the previously described devices 1 and 1′ in that the positioning element 12 comprises a number of elastic elements 12.5, which are configured to radially compensate for tolerances between the connecting screw 4 and the compensation element 10 and to hold the positioning element 12 together with the connecting screw 4 held therein in the compensation element 10 without clearance. For this purpose, the positioning element 12 is clamped against an inner wall 10.7 of the compensation element 10 by means of its elastic elements 12.5. In particular, the positioning element 12 is held radially in the compensation element 10 without clearance.

The elastic elements 12.5 can, for example, be designed as tensioning elements, tensioning arms, radial compensation spring elements, spring arms or flexible propeller arms.

The positioning element 12 comprises, for example, a base body 12.6, in particular a cylindrical, sleeve-shaped or ring-shaped body. The base body 12.6 forms the sleeve 12.0 in particular.

The elastic elements 12.5 protrude radially outwards from the base body 12.6 at an acute angle. In particular, a plurality of elastic elements 12.5 can be arranged symmetrically distributed on the outside of the base body 12.6. The elastic elements 12.5 are, on the one hand, firmly connected to the base body 12.6 or are formed integrally with it and, on the other hand, comprise free ends that rest elastically against a contact surface of the inner wall 10.7 of the compensation element 10.

In other words, the elastic elements 12.5 are fastened to the base body 12.6, in particular to an existing sleeve 12.0, for example as guide elements in the form of propeller arms, in order to allow for radial centering and return to the original position.

By means of the elastic elements 12.5, the positioning element 12 and the connecting bolt 4 or the connecting screw 4 held in it can be held centered and/or radially preloaded without clearance in the compensation element 10, in particular in its axial through-opening 10.2. In particular, the connecting bolt 4 or the connecting screw 4 is held clamped in the compensation element 10, in particular in the receiving channel 12.7 or in the axial through-opening 10.2 of the compensation element 10, by means of the elastic elements 12.5.

In addition, the positioning element 12 can be configured in such a way that the connecting bolt 4 or the connecting screw 4 is held securely in the positioning element 12 against tilting.

In particular, the base body 12.6 can comprise an inner receiving channel 12.7 for the connecting screw 4, in particular for receiving the connecting screw 4. The inner receiving channel 12.7 can, for example, comprise an inner dimension that is smaller than an external dimension of the connecting screw 4, so that the latter is held in the receiving channel 12.7 in the inserted state.

Furthermore, the base body 12.6 can comprise a plurality of flexible wall sections 12.6.1 distributed in the circumferential direction, which form the inner receiving channel 12.7 for the connecting screw 4.

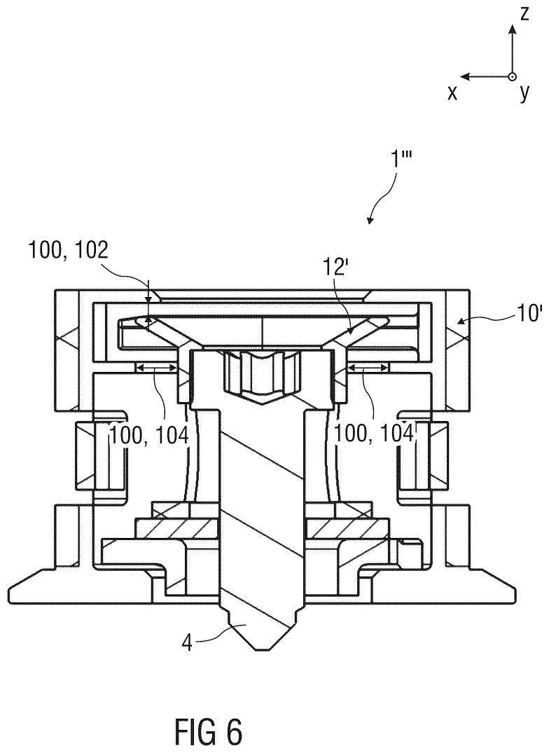

FIG. 6 is a schematic sectional view of a further alternative device 1″ with an alternative positioning element 12′, which is arranged centrally in an alternative compensation element 10′.

This further alternative device 1″ differs from the previously described devices 1 to 1″ in that the alternative positioning element 12′ comprises no shoulder section 12.3 and the alternative compensation element 10′ comprises no corresponding inner groove 10.3 (also called a pocket) for receiving the shoulder section 12.3.

In this case, the principle of pre-positioning and bearing of the connecting bolt 4 is effected with both an axial clearance 102 and a radial clearance 104 in the alternative compensation element 10′.

In this case, the alternative positioning element 12′ is secured axially in the alternative compensation element 10′. In particular, the alternative positioning element 12′ is secured and guided in the alternative compensation element 10′ at the top and bottom with the axial clearance 102 and/or laterally with the radial clearance 104.

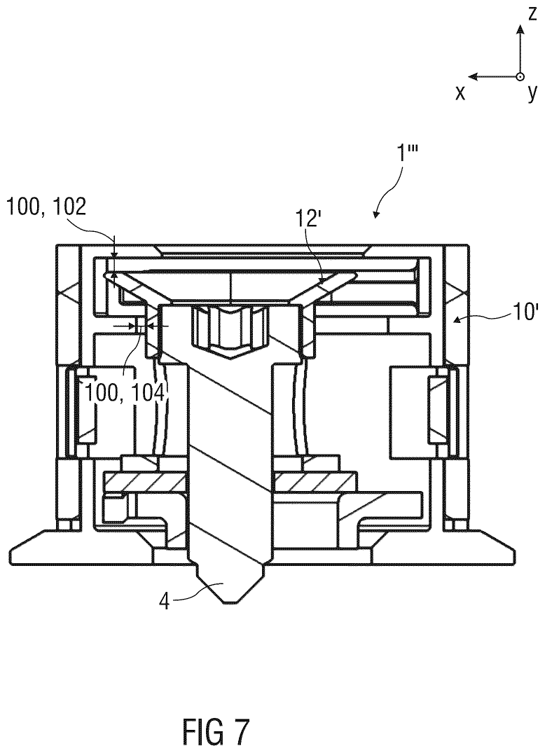

FIG. 7 is a schematic sectional view of the further alternative device 1′″ according to FIG. 6 with radially deflected alternative positioning element 12′, compensating for the radial clearance 104 in a lateral direction.

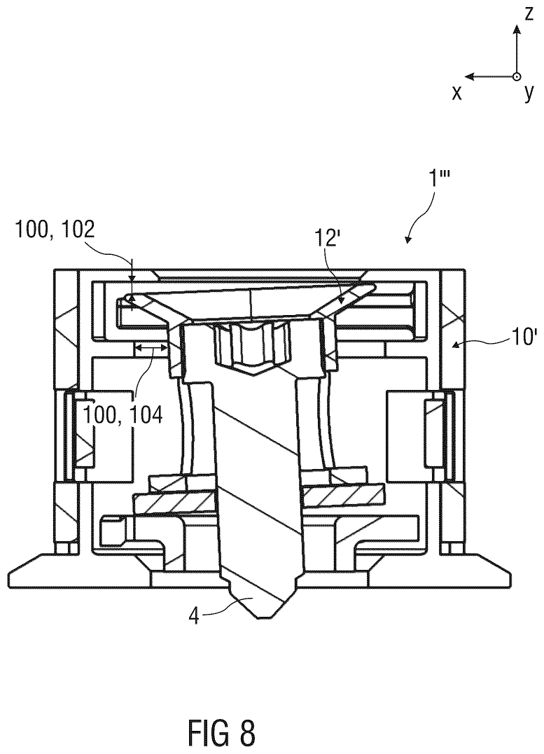

FIG. 8 is a schematic sectional view of the further alternative device 1′″ according to FIG. 6 with a tilted alternative positioning element 12′ with partial compensation of the axial clearance 102 and the radial clearance 104.

### LIST OF REFERENCE SIGNS

1, 1′, 1″, 1′″ Device for compensating for tolerances (tolerance compensation device)
2 First component
4 Connecting bolt/connecting screw
4.1 Screw head
6 Second component
6.1 Bore
7 Nut element
7.1 Nut thread
8 Base element
8.1 Internal thread
8.1.1 Thread sections
10, 10′ Compensation element
10.1 External thread
10.2 Axial through-opening
10.3 Inner groove
10.4 Bottom section
10.5 Further inner groove
10.6 Limiting lip
10.7 Inner wall
12, 12′ Positioning element
12.0 Sleeve
12.1 Entry funnel
12.2 Coupling section
12.3 Shoulder section
12.4 Driver section
12.5 Elastic elements
12.6 Base body
12.6.1 Wall section
12.7 Receiving channel
14 Washer
16 Compression limiter
18 Pre-assembly unit
100 Clearance
102 Axial clearance
104 Radial clearance
106 Further axial clearance
108 Further radial clearance

1. A device for compensating for tolerances between a first component and a second component that is to be screwed to this first component by means of a connecting screw or a threaded bolt, comprising:
a base element,
a compensation element in tolerance-compensating engagement with the base element and
a positioning element for positioning the connecting bolt in the compensation element,
wherein the positioning element is mounted with a clearance in at least one degree of freedom in a through-opening or without clearance in the compensation element.

2. The device according to claim 1,
wherein the positioning element is configured and arranged in the compensation element in such a way that the connecting bolt is mounted so as to be radially and/or axially movable to a limited extent.

3. The device according to claim 1,
wherein the positioning element is configured in such a way that the connecting bolt is held centered.

4. The device according to claim 1,
wherein the positioning element is configured and arranged in the compensation element in such a way that the connecting bolt is held securely in a predetermined position prior to assembly.

5. The device according to claim 1,
wherein the positioning element is arranged in such a way that the connecting bolt is held securely in the positioning element against tilting.

6. The device according to claim 1,
wherein the positioning element comprises a number of elastic elements, which are configured to radially compensate for tolerances between the connecting bolt and the compensation element and to hold the positioning element in the compensation element without clearance.

7. The device according to claim 6,
wherein the positioning element comprises a base body from which the elastic elements protrude radially outwards at an acute angle.

8. The device according to claim 7,
wherein the base body comprises an inner receiving channel for the connecting bolt.

9. The device according to claim 8,
wherein the receiving channel comprises an internal dimension that is smaller than an external dimension of the connecting bolt, so that the latter is held in the receiving channel in the inserted state.

10. The device according to claim 8,
wherein the base body comprises a plurality of flexible wall sections distributed in the circumferential direction, which form the inner receiving channel.
